(19) United States
(12) Patent Application Publication
(10) Pub. No.: US 2014/0376597 A1
(43) Pub. Date: Dec. 25, 2014

(54) Measuring Instrument Assembly with Retainer Hook

(71) Applicants: Jason Corbett Gilley, Hacienda Heights, CA (US); Gus Ambrocio, Garden Grove, CA (US); Adolfo Wurts, Orange, CA (US)

(72) Inventors: Jason Corbett Gilley, Hacienda Heights, CA (US); Gus Ambrocio, Garden Grove, CA (US); Adolfo Wurts, Orange, CA (US)

(21) Appl. No.: 13/926,521

(22) Filed: Jun. 25, 2013

(51) Int. Cl. G01K 1/14

(52) U.S. Cl. CPC G01K 1/14
USPC 374/208

(57) ABSTRACT

This invention is a measuring instrument assembly having a probe for placement through an opening in an airway such as a duct for measuring physical parameters of an airstream flowing through the airway. The probe includes a hook arranged to engage an inner wall portion of the airway adjacent the opening to retain an end of the probe in a selected position inside the airway.

### BACKGROUND OF THE INVENTION

1. Field of the Invention

This invention relates generally to measuring instruments and particularly to thermometry. Still more particularly this invention relates to a thermometry device for use within the field of heating, ventilation air conditioning and refrigeration (HVACR) having a probe that includes a hook for retaining the probe in a selected position in an airway.

2. Description of the Prior Art

In making temperature measurements in HVACR applications it is sometimes desirable to retain a thermometer probe in a selected position in an airstream so that a technician may have both hands free for other tasks. At present, the commonly used hanging mechanisms are magnets. Magnets do not allow the user to take measurements while the probe is hanging from a narrow register, and they do not allow the user to take measurements when hanging a thermometry probe on ductwork. Magnets also have the disadvantage of being useful only when there is a suitable magnetic surface available to properly position the probe.

Other instruments have hooks extending from their housings. Such instruments have little or no utility in HVACR applications because of difficulties in finding suitable places to hang them while achieving suitable probe positioning.

### SUMMARY OF THE INVENTION

This invention is a measuring instrument assembly for placement through an opening in an enclosure for measuring physical parameters of an airstream flowing through the enclosure. The measuring instrument assembly includes a housing, an elongated probe formed as a metal rod having a first end thereof connected to the housing, and a hook formed in the probe for engaging an edge of an opening into the enclosure carrying an airstream to retain a second end of the probe in a selected position inside the airstream.

The invention may further include a ferrule around the first end of the metal rod, the ferrule having a notch formed in a side portion thereof, the notch being arranged such that an edge portion of the notch engages the edge of the opening in the enclosure. An end of the ferrule preferably is pivotally attached to the housing.

The invention may also comprise a measuring instrument assembly for measuring physical parameters of an airstream flowing through the enclosure, that includes a housing, an elongate probe having a first end thereof connected to the housing and having a second end formed to extend into the enclosure and a hook formed in the probe for engaging an edge of an opening in the enclosure to allow the measuring instrument assembly to hang from a side of the enclosure.

The probe is preferably configured to penetrate into soft ductwork without requiring an additional tool.

The invention may further comprise a thermometer assembly for measuring temperature of an airstream flowing through an enclosure that includes a housing and a probe extending from the housing, the probe being configured to extend through an opening in the enclosure into the airstream, the probe having a hook formed therein to keep the probe extending at least two inches inside the airstream.

### BRIEF DESCRIPTION OF THE DRAWINGS

FIG. 1 is a perspective view of the invention;

FIG. 2 is a partial perspective view of the invention showing a probe and ferrule assembly extending from a housing with an edge of a recessed portion of the ferrule engaged with an edge of an opening in a wall of an enclosure; and

FIG. 3 is a top plan view of the invention.

### DETAILED DESCRIPTION OF THE INVENTION

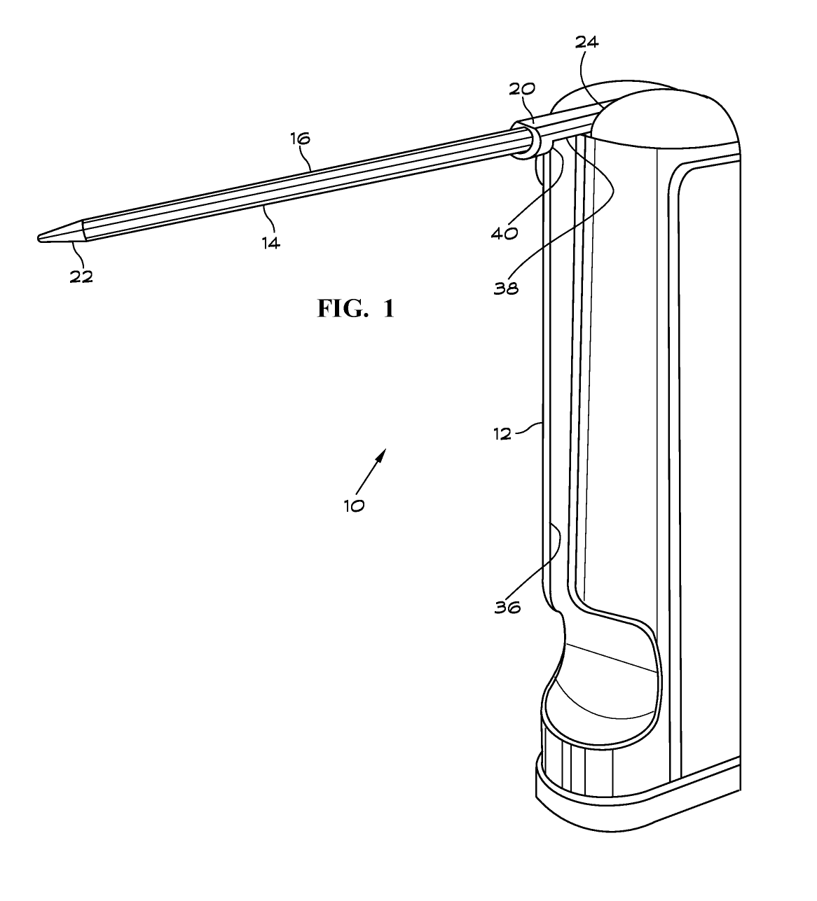

Referring to FIG. 1, a measuring instrument assembly 10 includes a housing 12 and a probe 14 that is preferably formed as an elongated stainless steel rod 16 that has a first end 18 extending from a ferrule 20 that may be conveniently formed of a plastic material molded over the stainless steel rod. The probe 14 preferably has a second end 22 formed to have a generally conical configuration.

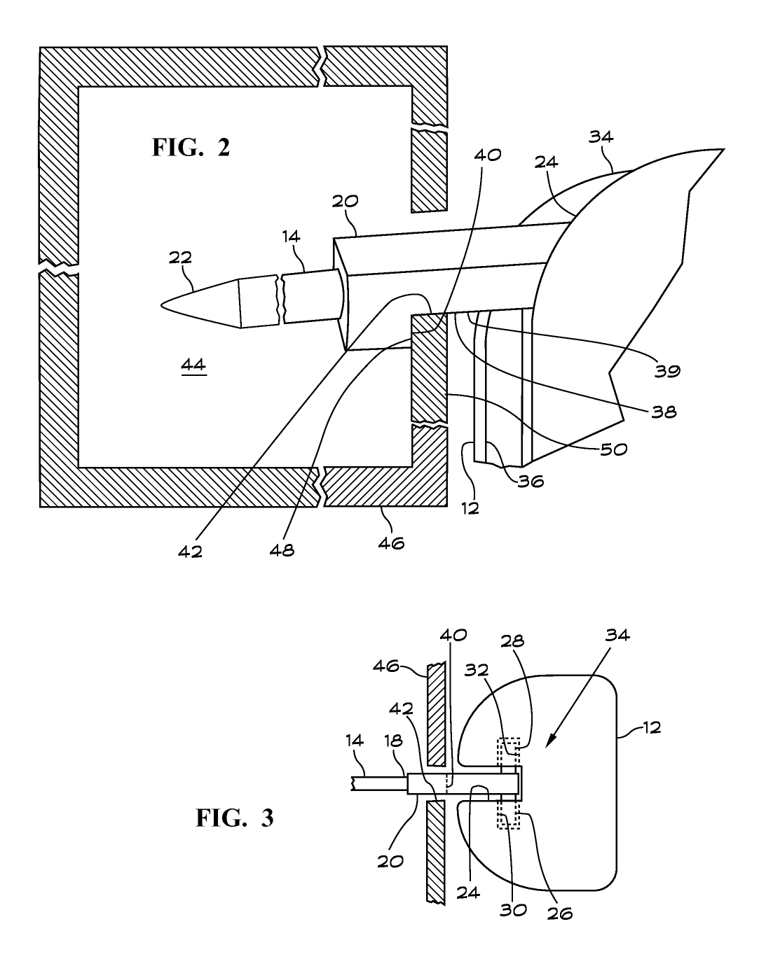

As shown in FIG. 2, the ferrule 20 preferably is pivotally mounted in a slot 24 in the housing 10. A pair of cylindrical projections 26 and 28 extends from opposite sides of the ferrule into corresponding cylindrical recesses 30 and 32, respectively, in an upper portion 34 of the housing 12. When deployed for use, the probe 14 may be arranged in a wide range of angles relative to the housing 12. The angular position of the probe 14 as shown herein is only by way of example to show how the invention may be used. When the a measuring instrument assembly 10 is being stored or transported, the probe 14 may be conveniently pivoted toward the housing 10 into a lower portion 36 of the slot 24.

Referring to FIGS. 1-3, the ferrule 20 preferably includes a notched portion 38 formed on a lower side portion 39 thereof. The notched portion 38 has an end wall 40 near an outer end portion of the ferrule 20. When being used to make measurements, the probe 14 and ferrule 20 extend through an opening 42 in an airway 44. The airway 44 may comprise a duct 46 or a grille (not shown), which may be in any form suitable for forming an airway.

If the duct 46 is formed of a soft material, the probe 14 is formed to penetrate through it to form an opening. The soft material bunches up under the notched portion 38 and allows the housing and probe 14 to hang from the side of the soft duct material.

FIGS. 2 and 3 show one example wherein the airway 44 is shown as a portion of a duct 46 made of a metal. After the probe 14 and ferrule are placed in the opening 42, the end wall 40 of the ferrule 20 extends over an inner surface portion 48 of the duct 46. Thus, the notched portion 38 and its end wall 40 functions as a hook configured to engage the wall portion 48 adjacent the opening 42 to retain the measuring instrument assembly 10 hanging on the outer wall 50 of the duct 46 with the probe 14 extending into the airway 44.

The probe 14 preferably includes a temperature sensor (not shown) such as a thermocouple or thermistor for sensing the temperature of air flowing through the airway in a manner well-known in the art. The end 22 of the probe 14 preferably is retained to extend about two inches inside the airway.

What is claimed is:

1. A measuring instrument probe assembly for placement through an opening in an enclosure for measuring physical parameters of an airstream flowing through the enclosure, comprising:
a housing;
an elongate probe formed as a metal rod having a first end thereof connected to the housing; and
a hook formed in the probe for engaging an edge of an opening into the enclosure carrying an airstream to retain a second end of the probe in a selected position inside the airstream.

2. The apparatus of claim 1 wherein the probe comprises a ferrule around the first end of the metal rod, the ferrule having a notch formed in a side portion thereof, the notch being arranged such that an edge portion of the notch engages the edge of the opening in the enclosure.

3. The apparatus of claim 1 wherein an end of the ferrule is pivotally attached to the housing.

4. A measuring instrument assembly for measuring physical parameters of an airstream flowing through the enclosure, comprising:
a housing;
an elongate probe having a first end thereof connected to the housing and having a second end formed to extend into the enclosure; and
a hook formed in the probe for engaging an edge of an opening in the enclosure to allow the measuring instrument assembly to hang from a side of the enclosure.

6. The A measuring instrument assembly of claim 5 wherein the probe is configured to penetrate into soft ductwork without requiring an additional tool.

7. A thermometer assembly for measuring temperature of an airstream flowing through an enclosure, comprising:
a housing; and
a probe extending from the housing, the probe being configured to extend through an opening in the enclosure into the airstream, the probe having a hook formed therein to keep the probe extending at least two inches inside the airstream.
